(19) United States
(12) Patent Application Publication
(10) Pub. No.: US 2016/0085671 A1
(43) Pub. Date: Mar. 24, 2016

(54) Three-Dimensional Mask-Programmed Read-Only Memory With Reserved Space

(71) Applicant: ChengDu HaiCun IP Technology LLC, ChengDu (CN)

(72) Inventor: Guobiao ZHANG, Corvallis, OR (US)

(73) Assignee: CHENGDU HAICUN IP TECHNOLOGY LLC, ChengDu (CN)

(21) Appl. No.: 14/491,999

(22) Filed: Sep. 20, 2014

(51) Int. Cl. G06F 12/02

(52) U.S. Cl. CPC G06F 12/0292; G06F 2212/2022; G06F 2212/1016

(57) ABSTRACT

The present invention discloses a 3D-MPROM with reserved space (3D-MPROM_{RS}). It comprise a reserved space, which contains no data in the original 3D-MPROM_{RS} but new contents in the updated 3D-MPROM_{RS}. For a small content revision, the data-mask can be salvaged. For a large content revision, the present invention further discloses a 3D-MPROM with reserved level (3D-MPROM_{RL}). It comprises at least a reserved level, which is absent in the original 3D-MPROM_{RL} but present in the updated 3D-MPROM_{RL}.

### CROSS-REFERENCE TO RELATED APPLICATIONS

This application is a continuation-in-part of U.S. patent application Ser. No. 13/846,928, “Mask-Programmable Memory with Reserved Space”, filed Mar. 18, 2013, which is a continuation-in-part of U.S. patent application Ser. No. 13/396,596, “Mask-Programmable Memory with Reserved Space”, filed Feb. 14, 2012, which is a continuation-in-part of U.S. patent application Ser. No. 12/883,172, “Three-Dimensional Mask-Programmable Memory with Reserved Space”, filed Sep. 15, 2010, which is a continuation-in-part of U.S. patent application Ser. No. 11/736,773, “Mask-Programmable Memory with Reserved Space”, filed Apr. 18, 2007, which is a non-provisional application of a U.S. Patent Application Ser. No. 60/884,618, “Mask-Programmable Memory with Reserved Space”, filed Jan. 11, 2007.

### BACKGROUND

1. Technical Field of the Invention

The present invention relates to the field of integrated circuits, and more particularly to three-dimensional mask-programmed read-only memory (3D-MPROM).

2. Prior Arts

For a three-dimensional mask-programmed read-only memory (3D-MPROM, disclosed in U.S. Pat. No. 5,835,396, issued to Zhang on Nov. 10, 1998, whose structure is also illustrated in FIG. 7A of this Specification), content is written using at least one data-mask during manufacturing process (step 10 of FIG. 1C). For example, a data-mask 2 comprises a plurality of mask-regions 2a-2i, whose patterns represent content data 4a-4i (FIG. 1A). Hereinafter, the pattern representing content data is referred to as data-pattern. Being permanently formed, the data-patterns cannot be modified once written onto the data-mask 2.

To include new contents in an updated 3D-MPROM, prior arts replace the original data-mask 2 with a new data-mask 2x (step 12 of FIG. 1C). For example, the new data-mask 2x includes the data-pattern of the new contents 4e* in the mask-region 2e (FIG. 1B), as well as the data-patterns for the original contents 4a-4d, 4f-4i. The original and new contents 4a-4d, 4e*, 4f-4i are written to the updated 3D-MPROM using the new data-mask 2x (step 14 of FIG. 1C).

As technology advances, data-mask becomes more and more expensive. For example, a 22 nm data-mask costs ˜$260 k. In addition, a data-mask contains more and more data. For example, a 22 nm data-mask could contain up to ˜155 GB data. Some of these data will likely be revised at a future point of time. Replacing a whole data-mask for small data revision is costly. To overcome this and other drawbacks, the present invention discloses a three-dimensional 3D-MPROM with reserved space (3D-MPROM_{RS}).

### Objects and Advantages

It is a principle object of the present invention to provide a 3D-MPROM that can economically accommodate content revision.

It is a further object of the present invention to provide a 3D-MPROM which salvages the original data-mask for content revision.

In accordance with these and other objects of the present invention, a 3D-MPROM with reserved space (3D-MPROM_{RS}) is disclosed.

### SUMMARY OF THE INVENTION

The present invention discloses a 3D-MPROM with reserved space (3D-MPROM_{RS}). For small content revision, the original data-mask can be salvaged. Hereinafter, small content revision means the amount of new contents that are to be included at a future point of time is substantially less than the original contents. On the original data-mask, at least one mask-region is reserved for new contents and has no data-pattern. This reserved mask-region can be used to write the data-pattern of the new contents when they become available. Versions of the 3D-MPROM_{RS}, including an original 3D-MPROM_{RS} and at least an updated 3D-MPROM_{RS}, collectively form a 3D-MPROM_{RS} family. 3D-MPROM_{RS} of different versions are same except for at least a reserved portion. The reserved portion in the original 3D-MPROM_{RS} stores no content and forms a reserved space, while the reserved portion in the updated 3D-MPROM_{RS} stores the new contents.

The present invention further discloses a three-dimensional 3D-MPROM with reserved memory level(s) (3D-MPROM_{RL}), which can accommodate large content revision. Versions of the 3D-MPROM_{RL}, including an original 3D-MPROM_{RL} and at least an updated 3D-MPROM_{RL}, collectively form a 3D-MPROM_{RL} family. 3D-MPROM_{RL} of different versions are same except for at least a reserved level, which is absent in the original 3D-MPROM_{RL} but present in the updated 3D-MPROM_{RL}. To be more specific, the original 3D-MPROM_{RL}, which is partially-loaded (i.e., its storage capacity is not fully utilized), comprises only enough memory levels for the original contents. As more contents become available, more memory levels will be manufactured for the updated 3D-MPROM_{RL} until it becomes fully-loaded (i.e., its storage capacity is fully utilized). Note that the original 3D-MPROM_{RL}, even though partially-loaded, is still fully functional. For all versions of the 3D-MPROM_{RL}, the peripheral circuits for the reserved memory levels are formed in the substrate.

### BRIEF DESCRIPTION OF THE DRAWINGS

FIGS. 1A-1B illustrate original and new data-masks in prior art; FIG. 1C discloses a data-writing method to the original and new 3D-MPROMs in prior art;

FIGS. 2A-2B illustrate exemplary original and updated data-masks 6, 6*; FIG. 2C discloses a preferred data-writing method to the original and updated 3D-MPROM_{RS}'s;

FIGS. 3AA-3AB are different views of an original 3D-MPROM_{RS} array 30; FIGS. 3BA-3BB are different views of an updated 3D-MPROM_{RS} array 30*;

FIG. 4 is a circuit block diagram of a preferred 3D-MPROM_{RS};

FIG. 5A discloses an exemplary address-mapping table of an original 3D-MPROM_{RS}; FIGS. 5B-5C disclose exemplary address-mapping tables of two updated 3D-MPROM_{RS}'s;

FIG. 6A is a cross-sectional view of a preferred 3D-MPROM with reserved memory level(s)(s) (3D-MPROM_{RL}) in its original version; FIG. 6B is a top view of its substrate; FIG. 6C is its circuit block diagram;

FIG. 7A is a cross-sectional view of the updated 3D-MPROM_{RL}; FIG. 7B is its circuit block diagram.

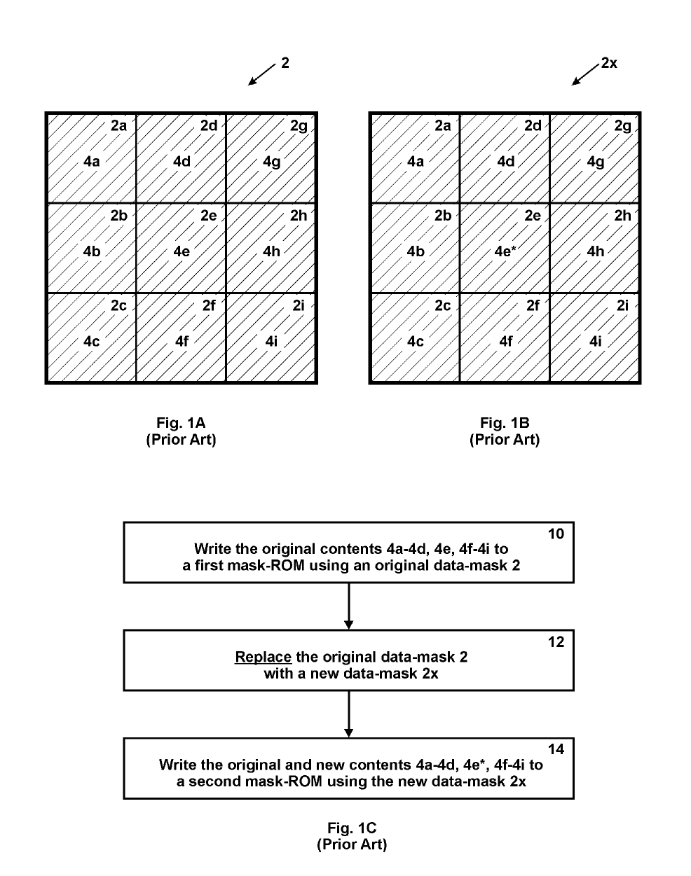

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

In this specification, the term “original” refers to the first version of the 3D-MPROM, which stores an initial collection of contents, i.e., original contents. The term “updated” refers to the second or later version of the 3D-MPROM, which stores a large portion of the original contents, plus at least a new content. The new contents could be included as an additional content, which adds to the original contents; or as an upgrade content, which replaces an outdated content in the original contents.

In this specification, “content” can be broadly interpreted as a standalone content or a component thereof. Hereinafter, “standalone content” refers to information which, by itself, provides value for an end-user in specific context. A content could be a single file or a collection of files. One example of content is a multimedia content, including a textual content, an audio content, an image content (e.g., a digital map) and/or a video content (e.g., a movie, a TV program, a video game). Another example of content is a computer program, including an operating system, a computer software for computers and/or an application software for cellular phones.

The present invention discloses a 3D-MPROM with reserved space (3D-MPROM_{RS}). For small content revision, the original data-mask can be salvaged. On the original data-mask, at least one mask-region is reserved for new contents and has no data-pattern. This reserved mask-region can be used to write the data-pattern of the new contents when they become available. Versions of the 3D-MPROM_{RS}, including an original 3D-MPROM_{RS} and at least an updated 3D-MPROM_{RS}, collectively form a 3D-MPROM_{RS} family. 3D-MPROM_{RS} of different versions are same except for a reserved portion. The reserved portion in the original 3D-MPROM_{RS} stores no content and forms a reserved space, while the reserved portion in the updated 3D-MPROM_{RS} stores the new contents.

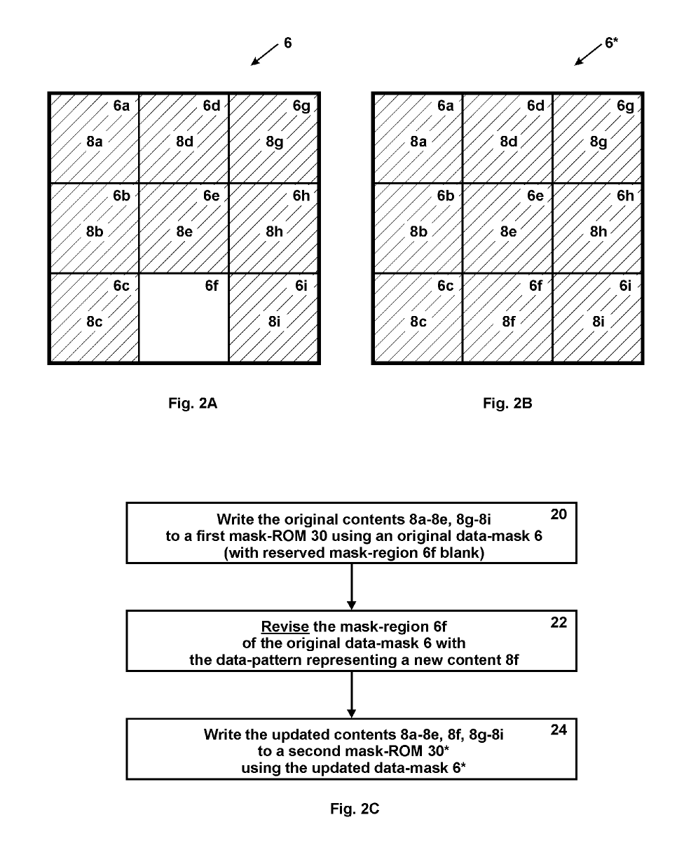

Referring now to FIGS. 2A-2C, the original and updated data-masks used for a preferred 3D-MPROM_{RS} and a preferred data-writing method are disclosed. The original data-mask 6 comprises a plurality of mask-regions 6a-6i (FIG. 2A). Most mask-regions 6a-6e, 6g-6i have data-patterns representing data for the original contents 8a-8e, 8g-8i. However, at least one mask-region 6f is reserved for at least a future new contents and has no data-pattern. This mask-region 6f is blank, i.e., either all dark or all clear. The original contents 8a-8e, 8g-8i are written into a first batch of 3D-MPROM_{RS}'s (i.e., original 3D-MPROM_{RS}'s) using the original data-mask 6 (step 20 of FIG. 2C).

When a new contents 8f needs to be included in an updated 3D-MPROM_{RS}, the data-pattern representing this new contents 8f is written to the reserved mask-region 6f (step 22 of FIG. 2C). As a result, the updated data-mask 6* contains the data-patterns representing the original contents 8a-8e, 8g-8i plus the new contents 8f (FIG. 2B). These contents 8a-8e, 8f, 8g-8i are written into a second batch of 3D-MPROM_{RS}'s (i.e., updated 3D-MPROM_{RS}'s) using the updated data-mask 6* (step 24 of FIG. 2C). In the present invention, because the first and second batches of 3D-MPROM_{RS}'s use the same data-mask 6 (with revision, not two different data-masks 2 and 2x as in prior arts), they are referred to as a 3D-MPROM_{RS} family. Because the original data-mask 6 is salvaged, little extra mask cost is incurred for small content revision. It should be noted that, to make it economically feasible to salvage the original data-mask, the original contents should occupy a substantial portion of the original data-mask.

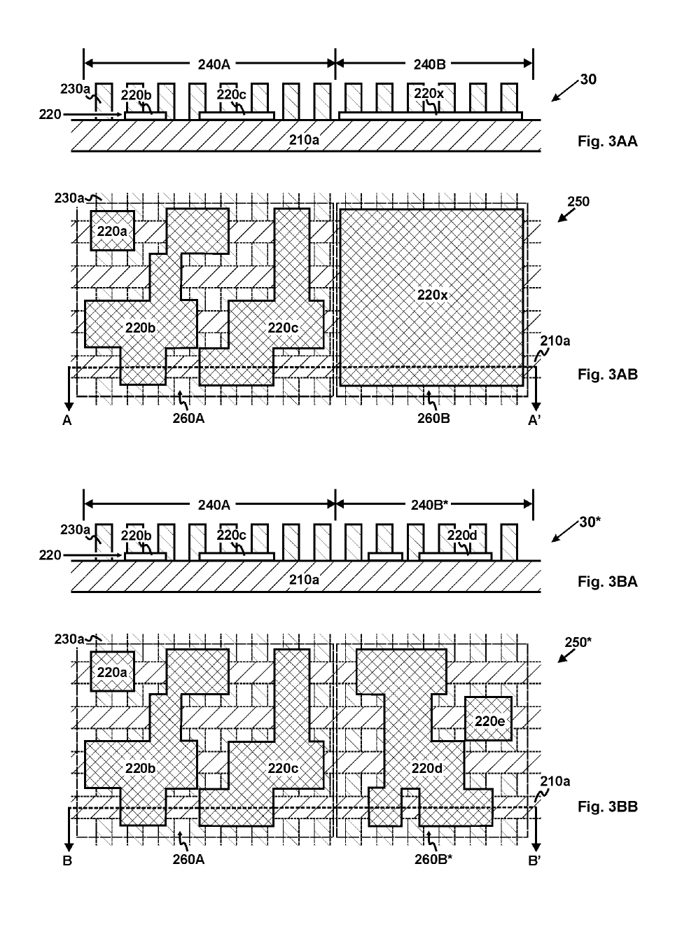

Referring now to FIGS. 3AA-3BB, an exemplary 3D-MPROM_{RS} array in its original and updated versions is disclosed. The 3D-MPROM_{RS} array 30 (or 30*) comprises a plurality of lower address lines (210a . . . ) and upper address line (230a . . . ) and 3D-MPROM cells. Each memory cell further comprises at least a data-layer 220, where the existence or absence of a contact via determines the digital state of the memory cell. Examples of the data-layer include an insulating dielectric or a resistive layer. The data-pattern of the data-layer is defined by the data-mask 6 (or 6*). For reason of simplicity, diodes, transistors and other memory components are not shown in FIGS. 3AA-3BB.

FIG. 3AA is a cross-sectional view of the original 3D-MPROM_{RS} array 30 along the cut-line AA′ of FIG. 3AB; FIG. 3AB is a top view of the data-pattern 250 of the data-layer 220 in the original 3D-MPROM_{RS} array 30 and its relative placement with respect to the address lines 210a . . . ; 230a . . . . The 3D-MPROM_{RS} array 30 comprises a first portion 240A and a second portion 240B. The first portion 240A corresponds to the region 260A of the data-layer 250, which has data-patterns 220a-220c. Accordingly, the memory cells in the first portion 240A are associated with a plurality of data blocks. They store the original content and form the original data space. On the other hand, the second portion 240B corresponds to the region 260B of the data-layer 250, which has no data-pattern, or just an all-dark pattern 220x. Accordingly, the memory cells in the second portion 240B are associated with a plurality of empty blocks. They store no content and form a reserved space. Hereinafter, a “block” is the smallest allocation unit of a memory that can be addressed by a user (or, a host). A “data block” is a block whose data has been written, while an “empty block” is a block whose data has not been written.

FIG. 3BA is the cross-sectional view of the updated 3D-MPROM_{RS} array 30* along the cut-line BB′ of FIG. 3BB; FIG. 3BB is the top view of the updated data-pattern 250* of the data-layer 220 and its relative placement with respect to the address lines 210a . . . ; 230a . . . . Here, the original data-patterns 220a-220c remain the same. However, the updated data-patterns 220d, 220e representing the new contents are written into the region 260B* of the data-layer 220. Accordingly, the memory cells in the second portion 240B* stores the new contents. To simplify manufacturing during content revision, it is preferred that the reserved portion 240B (240B*) is located at the topmost level of all memory levels in a 3D-MPROM.

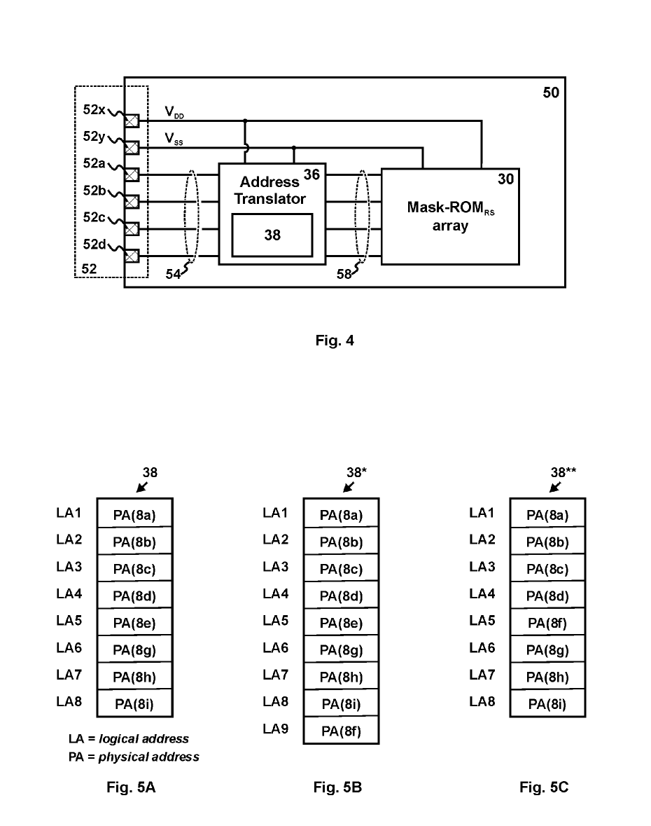

Referring now to FIGS. 4-5C, a preferred 3D-MPROM_{RS} 50 and its address-mapping tables are shown. As illustrated in FIG. 4, the preferred 3D-MPROM_{RS} 50 includes an interface 52 for physically connecting to and electrically communicating with a variety of hosts. The interface 52 includes contacts 52x, 52y, 52a-52d which are coupled to corresponding contacts in a host receptacle. For example, the host provides a voltage supply V_{DD} and a ground voltage V_{SS} to the 3D-MPROM_{RS} 50 through the power contact 52x and the ground contact 52y, respectively; the host further exchanges address/data with the 3D-MPROM_{RS} 50 through signal contacts 52a-52b. Hereinafter, a host is an apparatus that directly uses the 3D-MPROM_{RS} 50, and the address/data used by the host are logical address/data.

The preferred 3D-MPROM_{RS} 50 comprises at least a 3D-MPROM_{RS} array 30 and an address translator 38. The 3D-MPROM_{RS} array 30 is similar to those disclosed in FIGS. 3AA-3BB. The address translator 38 converts logical addresses from the host to physical addresses of the 3D-MPROM_{RS} array 30. Here, the logical addresses are represented on an internal bus 58, while the physical addresses are represented on an external bus 54 (including signals from contacts 52a-52d). The address translator 38 comprises a non-volatile memory (NVM) for storing an address mapping table 38, which maintains links between the logical addresses and the physical addresses. During read, upon receiving the logical address for the memory block to be read, the address translator 36 looks up the address mapping table and fetches the physical address corresponding to the logical address.

The preferred 3D-MPROM_{RS} 50 could comprise a plurality of 3D-MPROM_{RS} arrays. In addition, the 3D-MPROM_{RS} 30 and the address translator 36 could be formed on separate dies or on a single die. When formed on separate dies, the 3D-MPROM_{RS} array die and the address translator die could be vertically stacked or mounted side-by-side. They could form a multi-chip package (MCP) or a multi-chip module (MCM).

FIGS. 5A-5C disclose three exemplary address-mapping tables. Each address-mapping table comprises a plurality of entries. The addresses of these entries are logical addresses, while the data stored in these entries are physical addresses of the content data associated with the logical addresses. For example, the entry at logical address LA1 includes the physical address PA(8a) of at least one memory block storing at least a portion of the content 8a.

The first address-mapping table 38 in FIG. 5A is for an original 3D-MPROM_{RS} 30. Data are written into the original 3D-MPROM_{RS} 30 using the original data-mask 6 of FIG. 2A. The entries at logical addresses LA1-LA8 include the physical addresses for the contents 8a-8e, 8g-8i, respectively.

The second address-mapping table 38* in FIG. 5B is for a first preferred updated 3D-MPROM_{RS} 30*. Data are written into this updated 3D-MPROM_{RS} 30* using the updated data-mask 6* of FIG. 2B. In this updated 3D-MPROM_{RS} 30*, a new contents 8f is added to the original content. Accordingly, a new entry is added to the logical address LA9 of the address-mapping table 38*. It contains the physical address PA(8f) for the content 8f. To add new entries, the NVM storing the address-mapping table 38* is preferably a writable memory, which can be programmed at least once. One example of the writable memory is an antifuse-based memory, or a flash memory.

The third address-mapping table 38** in FIG. 5C is for a second preferred updated 3D-MPROM_{RS} 30*. Data are written into this updated 3D-MPROM_{RS} 30* using the updated data-mask 6* of FIG. 2B. In this updated 3D-MPROM_{RS} 30*, an upgrade content 8f is included to replace an outdated content 8e. Accordingly, the entry PA(8e) at LA5 is replaced by the physical address PA(8f) for the content 8f. In other words, the address-mapping table 38** does not contain the physical address of the outdated content 8e. To replace entries, the NVM storing the address-mapping table 38** is preferably a re-writable memory, which can be programmed many times. One example of the re-writable memory is a flash memory.

In the preferred embodiment of FIGS. 3AA-3BB, only a portion of a memory level is reserved for the new contents. This can only accommodate small content revision. To accommodate large content revision, a whole memory level can be reserved. Accordingly, the present invention discloses a 3D-MPROM with reserved memory level(s) (3D-MPROM_{RL}). Versions of the 3D-MPROM_{RL}, including an original 3D-MPROM_{RL} and at least an updated 3D-MPROM_{RL}, collectively form a 3D-MPROM_{RL} family. 3D-MPROM_{RL} of different versions are same except for at least a reserved level, which is absent in the original 3D-MPROM_{RL} but present in the updated 3D-MPROM_{RL}. To be more specific, the original 3D-MPROM_{RL}, which is partially-loaded (i.e., its storage capacity is not fully utilized), comprises only enough memory levels for the original contents. As more contents become available, more memory levels will be manufactured for the updated 3D-MPROM_{RL} until it becomes fully-loaded (i.e., its storage capacity is fully utilized).

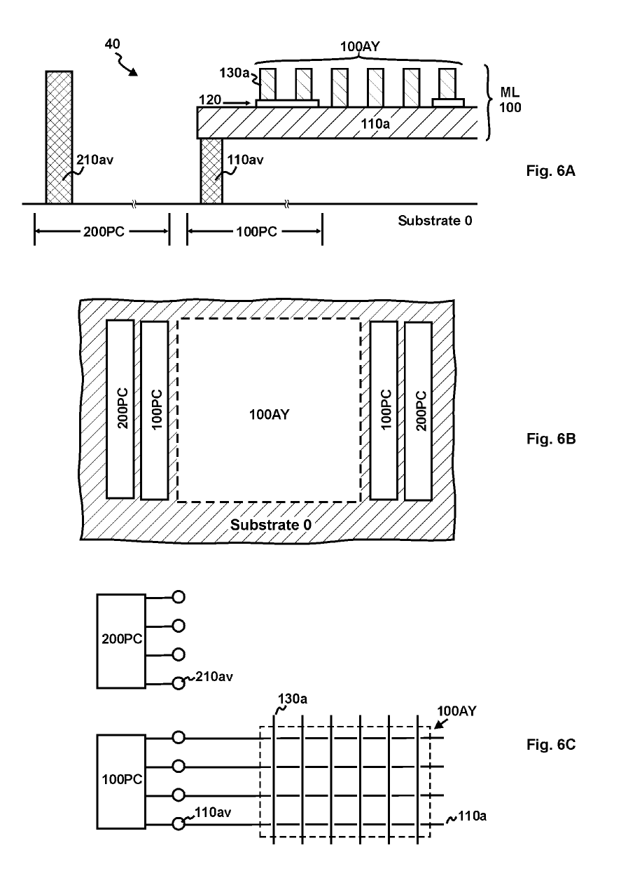

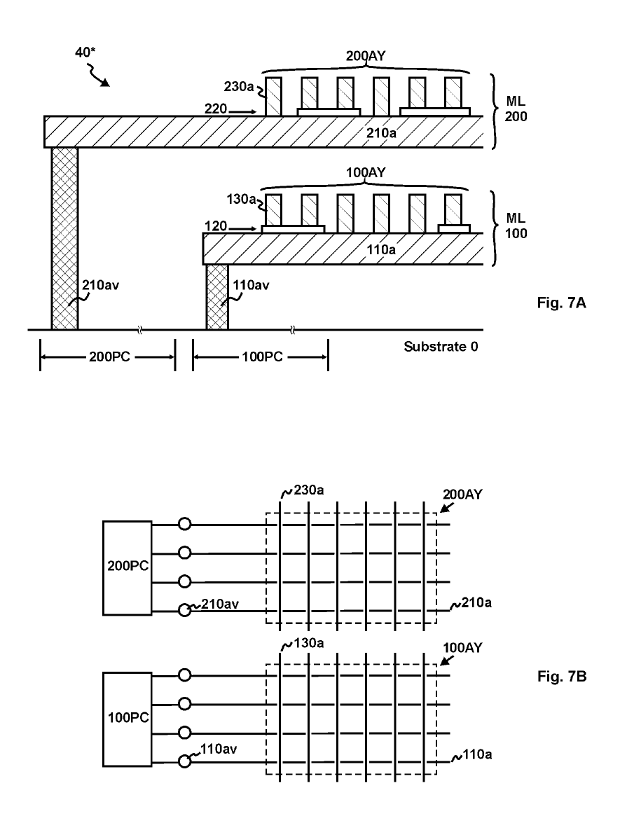

FIGS. 6A-7B disclose a preferred 3D-MPROM_{RL}. It comprises two memory levels, with the lowermost (i.e., first) memory level (i.e., the original memory level) storing the original contents, and the topmost (i.e., second) memory level (i.e., the reserved memory level) reserved for new contents.

FIGS. 6A-6C disclose various aspects of the original 3D-MPROM_{RL} 40. FIG. 6A is its cross-sectional view. The original 3D-MPROM_{RL} only comprises the first memory level 100, with the second memory level absent. The memory cells at the memory level 100 form a memory array 100AY. It stores the original contents, which are defined by the data-layer 120. The peripheral circuit 100PC for memory level 100 is formed in the substrate 0. It is coupled with the first memory level 100 through the contact vias (110av . . . ). It should be noted that, although the second memory level 200 is absent in the original 3D-MPROM_{RL} 40, its peripheral circuit 200PC and its contact via 210av are still formed.

FIG. 6B is a top view of the substrate 0 for the original 3D-MPROM_{RL} 40. It comprises the first peripheral circuit 100PC for the memory level 100, as well as the second peripheral circuit 200PC for the second memory level. In this figure, only the peripheral circuits along one address-line direction are drawn. It can be observed that, even though the reserved (second) memory level 200 is absent in the original 3D-MPROM_{RL} 40, its peripheral circuit 200PC is still formed in the substrate because the substrate circuits for all versions of the 3D-MPROM_{RL} are defined by the same mask set. The projected image of the memory array 100AY on the substrate 0 is also drawn in this figure.

FIG. 6C is a circuit block diagram for the original 3D-MPROM_{RL} 40. The first peripheral circuit 100PC is coupled to the memory array 100AY. The data stored in the memory array 100AY can be read out through the first peripheral circuit 100PC. For reason of simplicity, memory cells and their components (e.g. diodes) are not shown in this figure. The second peripheral circuit 200PC is not coupled to any memory array. Note that, the original 3D-MPROM_{RL}, even though partially-loaded, is fully functional.

FIGS. 7A-7B disclose various aspects of an updated 3D-MPROM_{RL} 40*. FIG. 7A is its cross-sectional view. The updated 3D-MPROM_{RL} is fully manufactured up to the memory level 200, which is formed on top of the original memory level 100. The memory cells at the memory level 200 form a memory array 200AY. The second memory level 200 stores the new contents, which are defined by the data-layer 220. The contact via 210av is extended and couples the second memory level 200 with its peripheral circuit 200PC.

FIG. 7B is a circuit block diagram for the updated 3D-MPROM_{RL} 40*. Note that the substrate circuits are the same for the original and updated versions of the 3D-MPROM_{RL}. The second peripheral circuit 200PC is coupled to the memory array 200AY. The data stored in the memory array 200AY can be read out through the second peripheral circuit 200PC. For reason of simplicity, memory cells and their components (e.g. diodes) are not shown in this figure.

The 3D-MPROM_{RL} is particularly advantageous for incremental content release. The original data-mask is used for all versions of 3D-MPROM_{RL}, while a new data-mask is used for the updated 3D-MPROM_{RL}. Hence, every data-mask is utilized to its full potential. In addition, because the new contents are stored in the memory level 200, which is formed above (not beside) the memory level 100, no substrate area in the original 3D-MPROM_{RL} needs to be allocated for the new contents. Hence, every substrate area is utilized to its full potential. In sum, the 3D-MPROM_{RL} can minimize extra mask cost and extra chip cost from content revision.

While illustrative embodiments have been shown and described, it would be apparent to those skilled in the art that may more modifications than that have been mentioned above are possible without departing from the inventive concepts set forth therein. The invention, therefore, is not to be limited except in the spirit of the appended claims.

What is claimed is:

1. A three-dimensional mask-programmed read-only memory with reserved space (3D-MPROM_{RS}) family, comprising:
a first 3D-MPROM die comprising at least a first 3D-MPROM array including a plurality of vertically stacked memory levels;
a second 3D-MPROM die comprising at least a second 3D-MPROM array including a plurality of vertically stacked memory levels;
wherein said first and second 3D-MPROM arrays are same except for a reserved portion, said reserved portion comprising a same plurality of memory cells in said first and second memory arrays, wherein all memory cells in the reserved portion of said first memory array have a same structure, and the memory cells in the reserved portion of said second memory array have at least two structures.

2. The 3D-MPROM_{RS} family according to claim 1, wherein all memory cells in the reserved portion of said first 3D-MPROM array comprise a data layer.

3. The 3D-MPROM_{RS} family according to claim 1, wherein all memory cells in the reserved portion of said first 3D-MPROM array comprise no data layer.

4. The 3D-MPROM_{RS} family according to claim 1, wherein at least selected memory cells in the reserved portion of said second 3D-MPROM array comprise a data layer.

5. The 3D-MPROM_{RS} family according to claim 1, wherein at least selected memory cells in the reserved portion of said second 3D-MPROM array comprise no data layer.

6. The 3D-MPROM_{RS} family according to claim 1, wherein said reserved portion is located at the topmost level of said memory levels.

7. The 3D-MPROM_{RS} family according to claim 1, wherein each of said first and second 3D-MPROM dice further comprises an address translator.

8. The 3D-MPROM_{RS} family according to claim 7, wherein said address translator comprises a non-volatile memory for storing an address-mapping table.

9. The 3D-MPROM_{RS} family according to claim 8, wherein said non-volatile memory is a re-writable memory.

10. The 3D-MPROM_{RS} family according to claim 9, wherein said re-writable memory is a flash memory.

11. A three-dimensional mask-programmed read-only memory with reserved level (3D-MPROM_{RL}) family, comprising:
a first 3D-MPROM die comprising at least a first 3D-MPROM array including a first plurality of vertically stacked memory levels;
a second 3D-MPROM die comprising at least a second 3D-MPROM array including a second plurality of vertically stacked memory levels;
wherein said first and second 3D-MPROM arrays are same except for at least a reserved memory level, said reserved level being absent in said first 3D-MPROM die but present in said second 3D-MPROM die.

12. The 3D-MPROM_{RL} family according to claim 11, wherein the memory cells in said reserved memory levels having at least two structures.

13. The 3D-MPROM_{RL} family according to claim 11, wherein said first and second pluralities of memory levels differ by said reserved memory level.

14. The 3D-MPROM_{RL} family according to claim 11, wherein said second plurality of memory levels include said first plurality of memory levels.

15. The 3D-MPROM_{RL} family according to claim 14, wherein said reserved memory level is stacked on top of said first plurality of memory levels.

16. The 3D-MPROM_{RL} family according to claim 11, wherein both substrates of said first and second 3D-MPROM dice comprises the peripheral circuits of said reserved memory level.

17. The 3D-MPROM_{RL} family according to claim 11, wherein each of said first and second 3D-MPROM dice further comprises an address translator.

18. The 3D-MPROM_{RL} family according to claim 17, wherein said address translator comprises a non-volatile memory for storing an address-mapping table.

19. The 3D-MPROM_{RL} family according to claim 18, wherein said non-volatile memory is a re-writable memory.

20. The 3D-MPROM_{RL} family according to claim 19, wherein said re-writable memory is a flash memory.
